(19) United States
(12) Patent Application Publication
(10) Pub. No.: US 2014/0334552 A1
(43) Pub. Date: Nov. 13, 2014

(54) IMAGE DECODING DEVICE

(71) Applicant: Panasonic Corporation, Osaka (JP)

(72) Inventors: Satoshi YAMAGUCHI, Hyogo (JP); Masao KITAGAWA, Hyogo (JP)

(21) Appl. No.: 14/339,702

(22) Filed: Jul. 24, 2014

Related U.S. Application Data
(63) Continuation of application No. PCT/JP2013/000331, filed on Jan. 23, 2013.

(30) Foreign Application Priority Data
Jan. 31, 2012 (JP) 2012-018929

(51) Int. Cl. H04N 19/44; H04N 19/91

(52) U.S. Cl. CPC H04N 19/00533; H04N 19/00951
USPC 375/240.25

(57) ABSTRACT

An image decoding device includes: an arithmetic decoding unit performing arithmetic decoding of a bitstream to obtain a binary symbol; and a bitstream decoding control unit selecting a bitstream on which the arithmetic decoding is performed by the arithmetic decoding unit. The bitstream decoding control unit causes the arithmetic decoding unit to suspend the arithmetic decoding one bit stream and start the arithmetic decoding of another bitstream at a time point when a predetermined time period elapses, and suspend the arithmetic decoding of the other bitstream and resume the arithmetic decoding of the one bitstream at a time point when another predetermined time period elapses.

### CROSS REFERENCE TO RELATED APPLICATIONS

This is a continuation application of PCT International Application No. PCT/JP2013/000331 filed on Jan. 23, 2013 designating the United States of America, which is based on and claims priority of Japanese Patent Application No. 2012-018929 filed on Jan. 31, 2012. The entire disclosures of the above-identified applications, including the specifications, drawings and claims are incorporated herein by reference in their entirety.

### FIELD

An embodiment of the present invention provides a decoding device and a decoding method for decoding a bitstream including an arithmetically encoded code.

### BACKGROUND

Recent years have seen the need for decoding processing of two bitstreams, for high-definition images, which are encoded with a highly efficient image coding standard. Typical such decoding processing is reproduction of 3D images whose services have been started through optical discs (Blu-Ray) and broadcasting. In addition, along with the sophistication of digital TV receivers in late years, required are not only 3D reproduction but also simultaneous decoding processing of many images, such as recording of images for long hours, co-operation among other digital devices, and teleconferencing and videotelophony among multiple locations.

An increasing number of image encoding standards are introducing arithmetic coding as element technologies for highly efficient encoding. H.264 is a leading standard which adopts the arithmetic coding. H.264 adopts an entropy encoding technique referred to as Context-Adaptive Binary Arithmetic Coding (CABAC) which adoptively selects an efficient context depending on environments.

The arithmetic coding involves encoding by expressing, on the number line, a bit string as a single number. Here the bit string is a multi-valued symbol which is binarized into a binary symbol Encoding is to determine, from a context defined for each of binary symbols, an occurrence probability of the symbol, divide the interval 0 to 1 on the number line depending on the occurrence probability, and designate, as an encoded bit-stream, the number having the shortest bit length indicating the finally selected divided interval.

In contrast, the arithmetic decoding is to determine, from the context of a binary symbol to be currently decoded, an occurrence probability of the symbol, divide the interval 0 to 1 on the number line depending on the occurrence probability, and obtain the binary symbol depending whether a position, at which an encoded bitstream indicates for each division, is closer to either 0 or 1 in the divided interval.

The binary symbol obtained by the arithmetic decoding is converted into a multi-valued symbol in the succeeding processing. CABAC is to update the occurrence probability of the binary symbol according to the value of the binary symbol, and adaptively select the context of a binary symbol to be processed next. Hence CABAC calculates the most suitable occurrence probability for each binary symbol to improve compression efficiency.

The arithmetic decoding processing has to be sequentially executed and cannot be executed in parallel. Thus the number of binary symbols after the arithmetic decoding determines a performance requirement, and high processing performance is required for the decoding processing. Considering the maximum quantity of bits per picture defined by H.264 level 4.1, for example, the required bit rate processing performance should be as fast as 500 Mbps.

For typical decoding processing in CABAC which often requires real-time performance, Patent Literature (PTL) 1 discloses in FIG. 1a decoder to reduce required performance using a buffer which is provided after an arithmetic decoder and accumulates binary symbols. The disclosed decoder includes the buffer for accumulating binary symbols between (i) an arithmetic decoder for executing arithmetic decoding processing on an input bitstream (binary arithmetic code) to obtain a binary symbol and (ii) a first data decoder for decoding the binary symbol to obtain output data. This allows the arithmetic decoder and the first data decoder to separately operate. Then the decoder obtains a binary signal by executing the arithmetic decoding depending on the input rate of the binary arithmetic code. Concurrently, the decoder reads the binary signal depending on an output (decoded image displaying) rate, and converts the binary signal into a multi-valued signal. This allows the required performance for the arithmetic decoding to be defined by an input bitrate, and reduces the required performance.

### CITATION LIST

### Patent Literature

[PTL 1]

WO 2005/041420

### SUMMARY

### Technical Problem

The H.264 standard defines slices, and the slices include all of the following: compressed data, a parameter required for decoding processing of the compressed data, and a range to be referred to as a context. Hence, when a single decoding device performs decoding processing on multiple bitstreams, the bitstreams can be switched for each slice. In an image to be reconstructed, a single picture may include multiple slices; instead, the single picture may also include a single slice.

In the case where a single picture includes a single slice, the bitstreams are to be switched for each picture when a single decoding device performs decoding processing on multiple bitstreams. As described before, it is known that the time for arithmetic decoding processing takes longer depending on the number of binary symbols after the arithmetic decoding. Suppose the case where two bitstreams both having the same bitrate are decoded: if a bit count of a picture is disproportionate between the two bitstreams, decoding processing of one of the bitstreams could locally takes more time than the decoding of the other. Consequently, a sufficient time cannot be spent for the decoding processing of the other bitstream.

If a decoding device whose processing capability is of 80 Mbps processes two bitstreams each having the bitrate of 40 Mbps, for example, processing time needs to be equally allocated between the two bitstreams. However, when the decoding device executes decoding processing as illustrated in the exemplary operation represented in FIG. 2 and disproportion in processing time occurs as illustrated in the allocation of processing time in FIG. 2, more processing time is inevitably spent on the bitstream A and the bitstream B cannot be processed.

The decoding device could continue decoding processing at a certain processing rate; however, an equal processing rate cannot be distributed for each of the bitstreams, In other words, the decoding device might not be able to execute the decoding processing at a processing rate faster than or equal to a bitrate required for each bitstream. Failure to execute the decoding processing at a processing rate faster than or equal to the bitrate will cause overflow at an input and underflow at an output, which results in delay in image displaying and failure in smooth video reproduction.

Thus, for example, if two bitstreams require an equal bitrate, it is desirable to allocate the same time for processing times of both the bitstreams. In order to allocate the same time for processing times of both the bitstreams, the decoding processing needs to be switched in time division. Then, in order to achieve the switching, suspension of the decoding and resume of the decoding where the decoding is suspended need to be executed by an arithmetic decoder.

When an arithmetic decoder with a low required performance suspends decoding processing by CABAC as disclosed in a conventional technique, resuming the suspended decoding processing requires to go back the bitstream to the head of the slices and to execute arithmetic decoding again, since a range to be referred to as a parameter and a context to be required for the decoding processing as described above is in the slices. This causes a waste of processing.

In addition, a large number of binary symbols could locally be generated. In such a case, the arithmetic decoder has to finish processing at least one slice within a fixed time. Otherwise, the processing has to be resumed at the head of the slices again. Consequently, the conventional technique faces problems of developing deadlock and inability of continuous decoding processing,

One non-limiting and exemplary embodiment provides a low-cost image decoding device which can independently and stably decode arithmetically coded multiple bitstreams.

### Solution to Problem

An image decoding device according to one non-limiting and exemplary embodiment decodes bitstreams, The image decoding device includes: an arithmetic decoding unit which performs arithmetic decoding of a bitstream to be inputted to obtain a binary symbol; and a control unit which selects a bitstream on which the arithmetic decoding is performed by the arithmetic decoding unit, wherein the control unit causes the arithmetic decoding unit to: suspend the arithmetic decoding of one of the bitstreams and start the arithmetic decoding of an other one of the bitstreams, at a time point when a predetermined time period elapses; and suspend the arithmetic decoding of the other one bitstream and resume the arithmetic decoding of the one bitstream at a time point when another predetermined time period elapses.

The above features make it possible to switch, in time division, and arithmetically decode multiple bitstreams, which contributes to implementing decoding processing on multiple bitstreams at a low cost. It is noted that the predetermined time period for the arithmetic decoding of the one bitstream and the predetermined time period for the arithmetic decoding of the other one bitstream may be the same or different in length.

It is noted when there are two bitstreams to be decoded (a first bitstream and a second bitstream), the above image decoding device, for example, (i) suspends decoding the first bitstream and starts decoding the second bitstream, and then (ii) suspends decoding the second bitstream and resumes decoding the first bitstream.

An embodiment of the present invention, however, shall not be limited this. An embodiment of the present invention is applicable to decoding three or more bitstreams. Here, “the other bitstream” includes multiple bitstreams (for example, a second bitstream and a third bitstream).

In such a case, the following exemplary operation by the image decoding device includes the scope of the above processing: the image decoding device (i) suspends decoding the first bitstream and starts decoding the other bitstream (the second bitstream), and then (ii) suspends decoding the other bitstream (the third bitstream) and starts decoding the first bitstream. In other words, performed between the processing (i) and the processing (ii) may be processing to suspend decoding the second bitstream and start decoding the third bitstream. The case where there are four bitstreams to be decoded may be thought as the same as above.

The image decoding device may further include an arithmetic decoding information saving and returning unit. The arithmetic decoding information saving and returning unit may save, as saved data, arithmetic decoding information regarding the one bitstream held in the arithmetic decoding unit, when the arithmetic decoding unit suspends the arithmetic decoding of the one bitstream, and may return the saved data to the arithmetic decoding unit when the arithmetic decoding unit resumes the arithmetic decoding of the one bitstream.

Such features make it possible to suspend and resume the arithmetic decoding at any given time point.

The image decoding device may further include an arithmetic decoding information saving and returning unit. The arithmetic decoding information saving and returning unit may, for each of units of decoding processing in any given number including at least one, save, as saved data, arithmetic decoding information regarding the one bitstream on which the arithmetic decoding is performed by the arithmetic decoding unit, and may return the saved data to the arithmetic decoding unit when the arithmetic decoding unit resumes the arithmetic decoding of the one bitstream.

As an example, each of the units of the decoding processing may be a macroblock line.

Moreover, each of the units of the decoding processing may be a macroblock.

Furthermore, each of the units of the decoding processing may be a residual.

In addition, each of the units of the decoding processing may be a residual.

As an example, the predetermined time period may be determined by a bitrate of a bitstream.

Furthermore, the predetermined time period may be determined according to a display rate time of a decoded image.

Moreover, the predetermined time period may be determined according to an image size of a decoded image.

As an example, the arithmetic decoding information may include at least current position information regarding syntax.

In addition, the arithmetic decoding information may include at least a BinIdx.

Furthermore, the arithmetic decoding information may include at least a CodIRange and a CodIOffset.

Moreover, the arithmetic decoding information may include at least a context.

In addition, the arithmetic decoding information may include at east a context index table.

Furthermore, the arithmetic decoding information may include at least a decoded binary symbol.

The image decoding device may further include an arithmetic decoding information saving and returning unit. The arithmetic decoding information saving and returning unit may save, as saved data at a predetermined time point, arithmetic decoding information being processed by the arithmetic decoding unit.

As an example, the predetermined time point may be when decoding is suspended.

Furthermore, the predetermined time point may be when decoding of a macroblock starts.

In addition, the predetermined time point may be when decoding of a residual starts.

Moreover, the predetermined time point may be when decoding of a residual_block starts.

It is noted that an embodiment of the present invention can be implemented not only as the above image decoding device and the like but also as an integrated circuit to achieve a function of the image decoding device and as a program to cause a computer to execute the function (method). As a matter of course, the program may be distributed via a recording medium such as a CD-ROM and a transmission medium such as the Internet. In addition, an embodiment of the present invention can be implemented as an integrated circuit to achieve a function of the image decoding device.

### Advantageous Effects

As described above, an embodiment of the present invention allows a single decoding device to switch, in time division, among multiple bitstreams in use, This feature makes it possible to implement decoding processing of multiple bitstreams at a low cost,

### BRIEF DESCRIPTION OF DRAWINGS

These and other objects, advantages and features of the invention will become apparent from the following description thereof taken in conjunction with the accompanying drawings that illustrate a specific embodiment of one non-limiting and exemplary embodiment.

FIG. 1 represents a block diagram illustrating a structure of an image decoding device disclosed in a prior art.

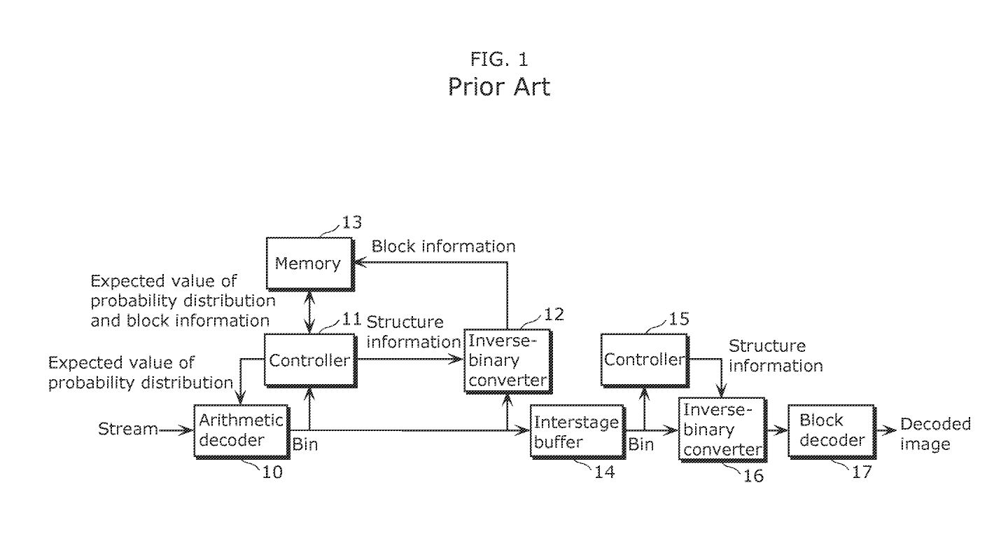

FIG. 2 represents an explanatory chart illustrating allocation of times in decoding processing on multiple bitstreams.

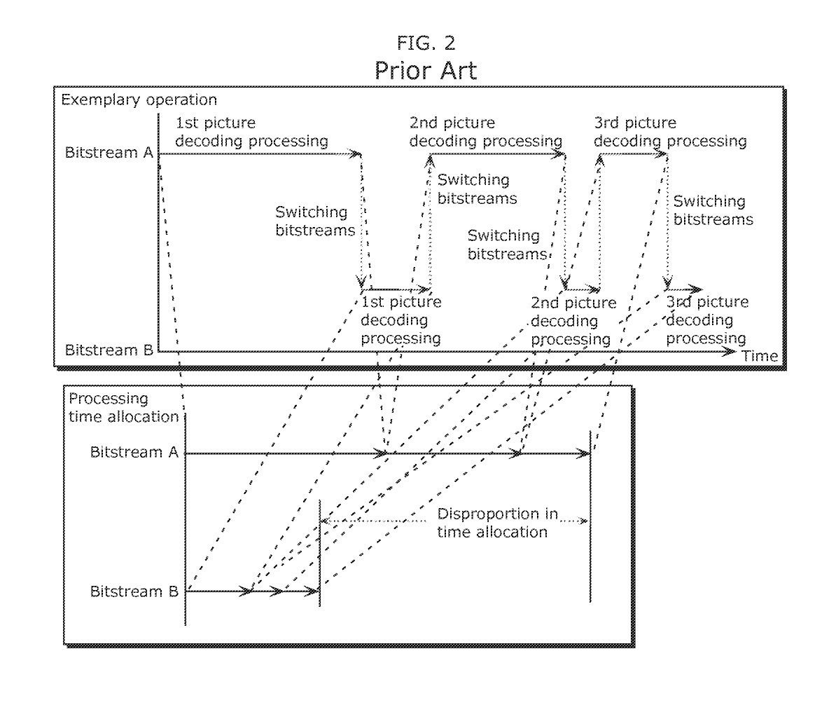

FIG. 3 represents a flowchart describing how to decode a slice layer.

FIG. 4 represents an explanatory chart illustrating how to decode a macroblock layer.

FIG. 5 represents an explanatory chart illustrating how to decode a macroblock layer.

FIG. 6 represents an explanatory chart illustrating how to decode a macroblock layer,

FIG. 7 represents an exemplary multi-value table of mb-type.

FIG. 8 represents a block diagram illustrating a structure of an image decoding device according to Example 1.

FIG. 9 represents an exemplary chart describing a structure of a slice layer.

FIG. 10 represents a flowchart describing how to decode a macroblock layer.

FIG. 11 represents a flowchart describing how to execute arithmetic decoding.

FIG. 12 represents an exemplary chart describing how to decode mb_type.

FIG. 13 represents an exemplary chart illustrating a controlled state of multi-value processing.

FIG. 14 represents an exemplary chart illustrating an arithmetic decoding information storage memory.

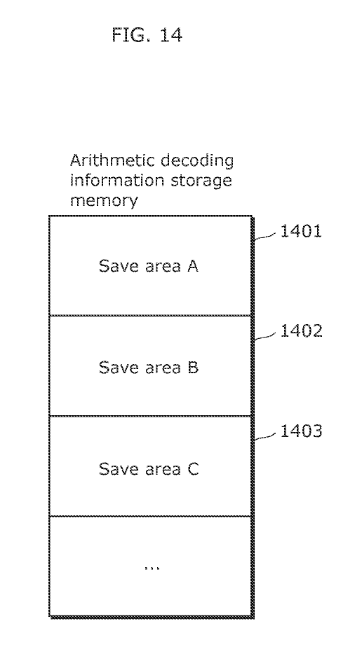

FIG. 15 represents a block diagram illustrating a structure of an image decoding device according to Example 2.

FIG. 16 represents a flowchart describing how to decode a slice layer.

FIG. 17 represents a flowchart describing how to decode a slice layer.

FIG. 18 represents a block diagram illustrating a structure of an image decoding device according to Example 6.

### DESCRIPTION OF EMBODIMENT

Described hereinafter is an image decoding device according to an embodiment of the present invention. It is noted that an embodiment of the present invention shall be identified based on the description of claims. Hence, among the constituent elements in the embodiment below, those not described in claims are not necessarily required to meet the requirements of an embodiment of the present invention. In other words, the embodiment below is to describe more beneficial form of an embodiment of the present invention. Moreover, each of the drawings is a schematic view, and does not necessarily present a precise illustration, Furthermore, each of Examples is an example of the embodiment to facilitate the understanding of the embodiment. The embodiment of the present invention shall not be limited to the Examples.

It is noted that each of the functional blocks in the embodiment may be implemented in the form of hardware, software, and a combination of hardware and software.

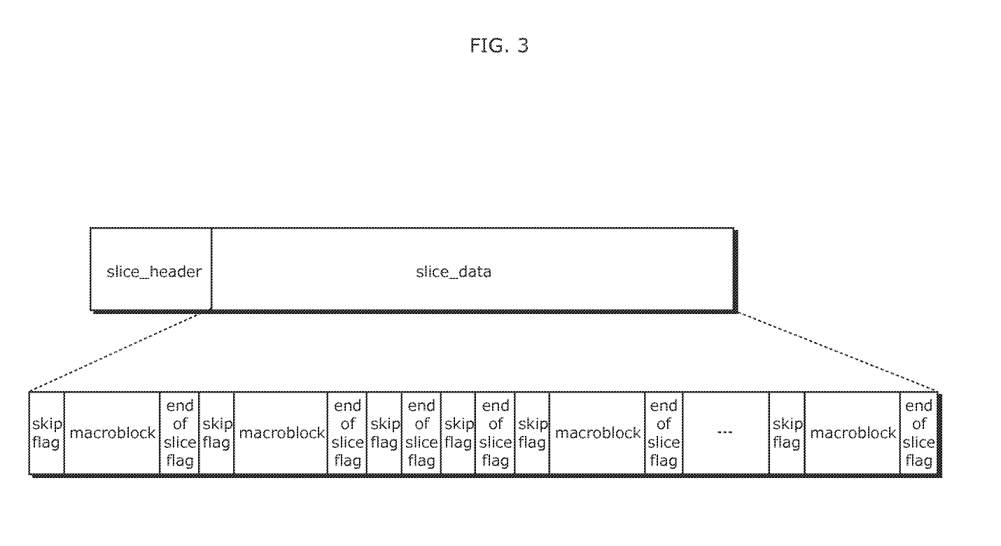

As represented in FIG. 3, a slice is divided into a slice_header and a slice_data included in a macroblock. The slice_data and a layer following the slice_data is a group of macroblocks. CABAC encoding is applied to the slice_data and a layer following the slice_data. As an example, the embodiment describes a case of controlling the decoding processing of the slice_data and a layer following the slice_data.

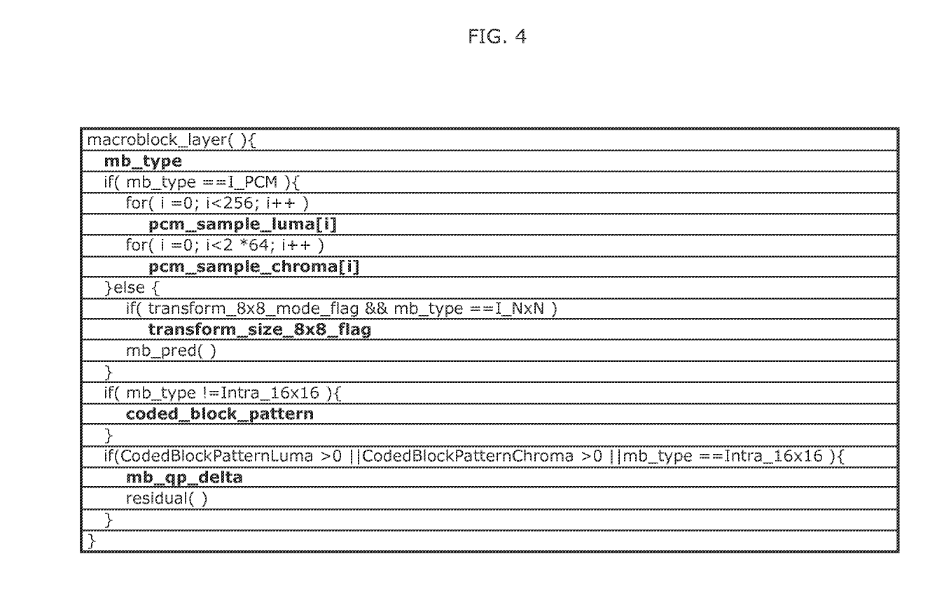

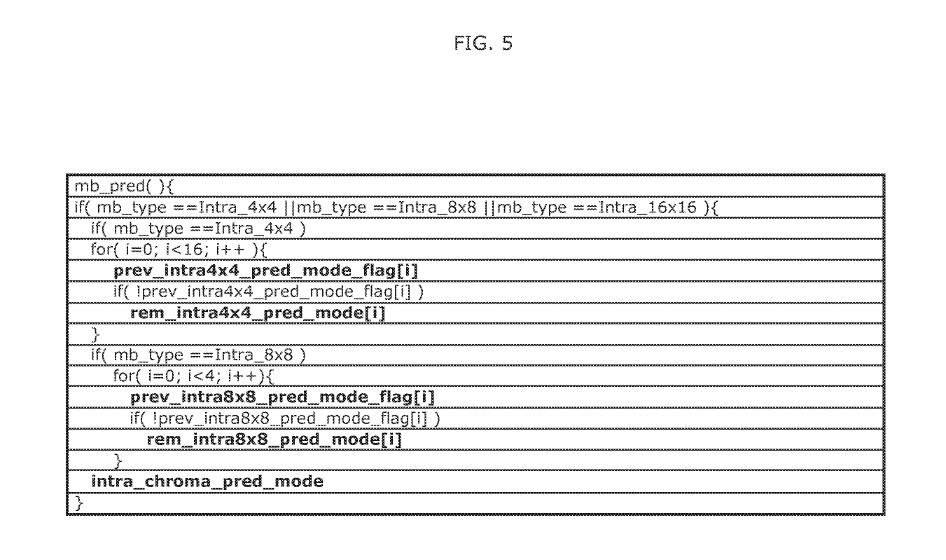

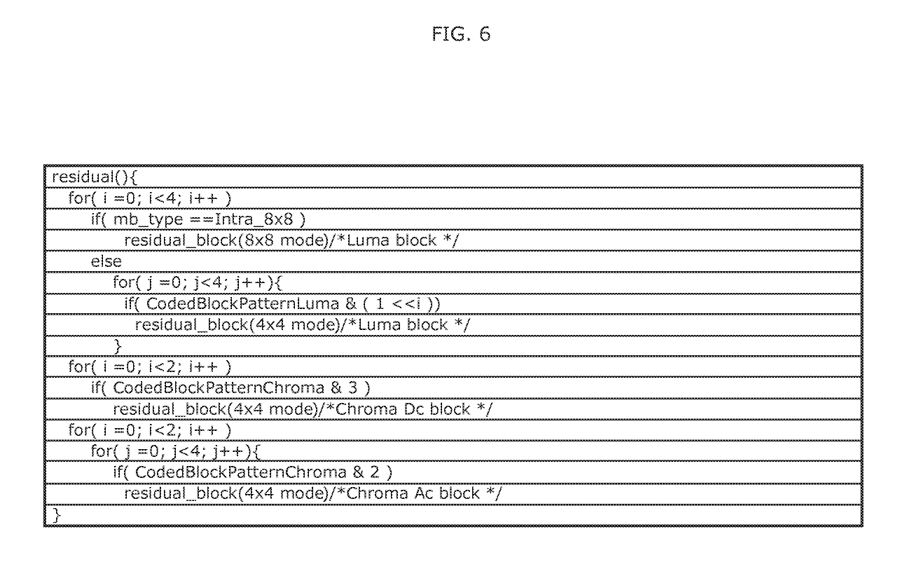

FIGS. 4 to 6 represent syntax of the macroblocks. Then, based on the value of a decoded parameter (multi-valued symbol), the symbol to be decoded next is determined according to the syntax. Here FIGS. 4 to 6 omit description of an intermacroblock.

The multi-valued symbol is obtained by multiple binary symbols. The length of a sequence of the binary symbols is variable. Hence the processing should be executed with determining whether or not a parameter is generated according to a multi-value table which defines a multi-valued symbol value corresponding to the symbol sequence of the binary symbols. In H.264, a binary symbol is referred to as Bin, and a number which is sequentially assigned to each of the binary symbols in a symbol sequence is referred to as BinIdx.

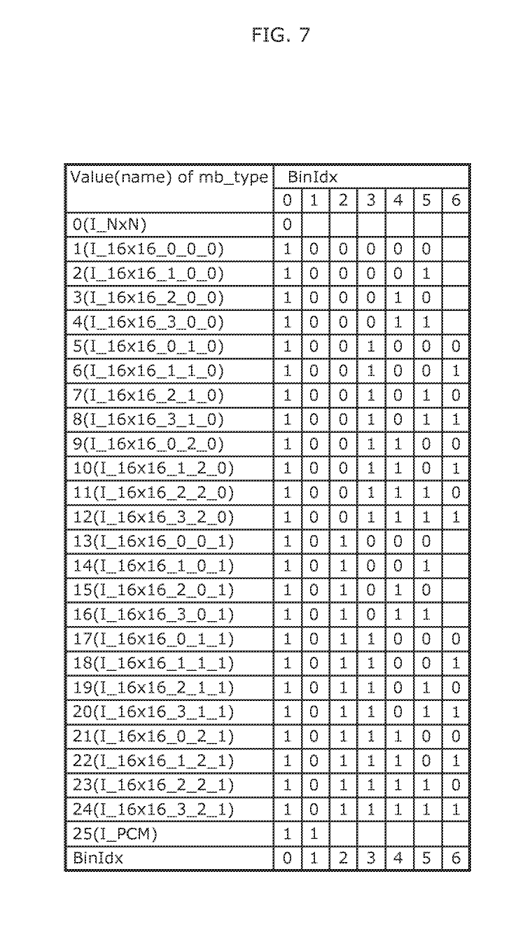

As an example, FIG. 7 represents a multi-value table of the mb_type for the intramacroblock. As described above, CABAC in H.264 involves adaptively calculating an occurrence probability according to a binary symbol. The occurrence probability is chosen from 64 kinds of tables. An index assigned to each of the tables is referred to as pStateIdx, Moreover, a table which defines a corresponding relationship indicating which pStateIdx is used when each binary symbol is under which condition is referred to as context index table.

In decoding a binary symbol, a context index of the binary symbol to be currently decoded is determined. Using the index, the pStateIdx is obtained from the context index table to obtain the occurrence probability. For the context index table, an initial value is determined when decoding of a slice starts. Each time a binary symbol is decoded, the processing is executed while adjusting the corresponding relationship according to the value of the binary symbol.

Furthermore, in determining the context index, the context of the binary symbol to be processed next needs to be selected. The context of the binary symbol to be processed next may be a parameter which belongs to the macroblock immediately before, a parameter which belongs to a neighboring macroblock, and a binary symbol which is decoded immediately before. In any cases, a previously decoded multi-valued symbol or binary symbol is the context.

According to the BinIdx of the binary symbol to be processed next and the value of the selected context, determined is a context index of the binary symbol to be processed next. The arithmetic decoding processing involves dividing the interval 0 to 1 on the number line according to an occurrence probability obtained by the determined context index, and outputting a binary symbol indicating whether a position at which an encoded bitstream indicates is closer to either 0 or 1 in the divided interval. In H.264, the position where an encoded bitstream indicates is referred to as CodIOffset and the interval 0 to 1 on the number line is referred to as CodIRange.

### Example 1

Described hereinafter is Example 1 which is an example of the embodiment.

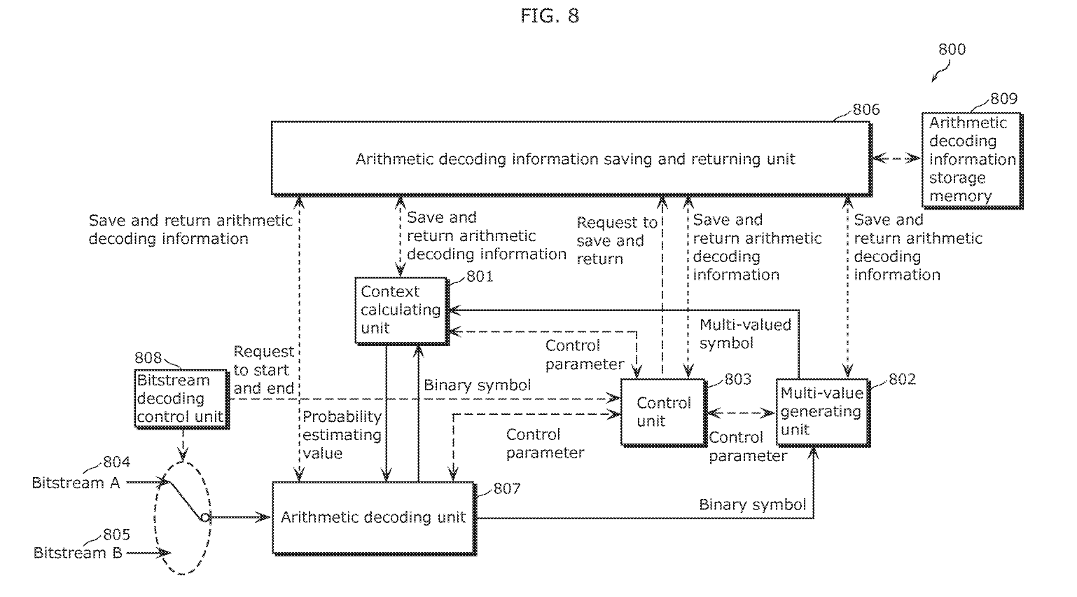

FIG. 8 represents a block diagram illustrating a structure of an arithmetic decoder (arithmetic decoding unit) 800 according to the embodiment. The arithmetic decoder 800 represented in FIG. 8 includes a control unit 803, an arithmetic decoding unit 807, a multi-value generating unit 802, a context calculating unit 801, an arithmetic decoding information saving and returning unit 806, an arithmetic decoding information storage memory 809, a bitstream decoding control unit 808, The arithmetic decoder 800 obtains a binary symbol from an arithmetically coded bitstream to be inputted.

The control unit 803 manages the syntax information regarding and BinIdx of a binary symbol to be processed next, and determines the succeeding processing according to the result of decoding. The arithmetic decoding unit 807 arithmetically decodes a bitstream based on an occurrence probability. The mufti-value generating unit 802 generates a multi-valued symbol based on the binary symbol.

The context calculating unit 801 stores a multi-valued symbol to be used as a context and a context index table. Specifically, the context calculating unit 801 outputs an occurrence probability determined based on the BinIdx of a binary symbol to be currently decoded, the multi-valued symbol stored as the context, the context index table, and the binary symbol. In addition, the context calculating unit 801 updates the context index table based on the decoded binary symbol.

The arithmetic decoding information saving and returning unit 806 saves, into the arithmetic decoding information storage memory 809, arithmetic decoding information held in the arithmetic decoding unit 807 when the arithmetic decoding information saving and returning unit 806 suspends arithmetic decoding processing. The arithmetic decoding information saving and returning unit 806 reads the arithmetic decoding information from the arithmetic decoding information storage memory 809 and sets the read arithmetic decoding information for the arithmetic decoding unit 807 when the arithmetic decoding information saving and returning unit 806 resumes the arithmetic decoding processing (in other words, the arithmetic decoding information saving and returning unit 806 returns the arithmetic decoding information). The bitstream decoding control unit 808 provides the arithmetic decoding unit 807 with a bitstream to be decoded, and controls the start and end of the decoding of the bitstream.

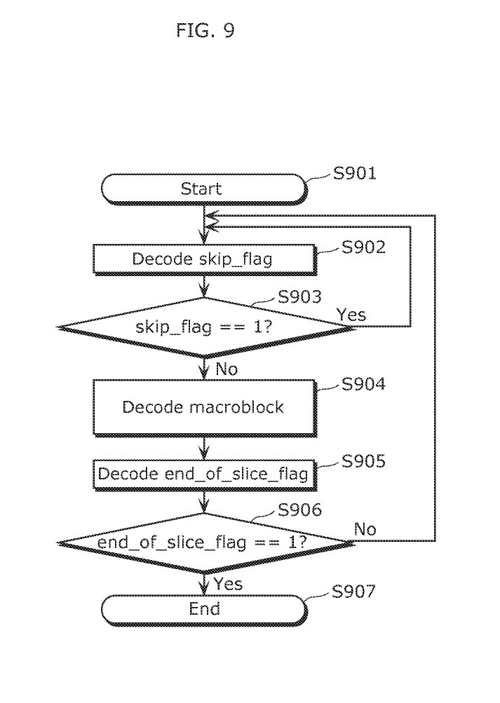

Described next is the processing executed by the arithmetic decoder 800 represented in FIG. 8, with reference to FIG. 9. It is noted that the slice_data has the structure illustrated in FIG. 3.

First, the arithmetic decoding unit 807 decodes a skip_flag included in the slice_data (S902). Then, using the skip_flag decoded in Step S902, the arithmetic decoding unit 807 determines whether or not a macroblock to be decoded is a skippedmacroblock (S903).

If the macroblock to be decoded is not the skippedmacroblock (S903: No), the arithmetic decoding unit 807 starts decoding processing on the macroblock (S904). After decoding processing on the macroblock, the arithmetic decoding unit 807 decodes an end_of_slice_flag included in the slice_data (S905). Then, using the end_of_slice_flag decoded in Step S905, the arithmetic decoding unit 807 determines whether or not the slice is at its end (S906).

If the slice is not at its end (S906: No), the arithmetic decoding unit 807 proceeds to determine a skippedmacroblock in the next macroblock. In contrast, if the slice is at its end (S906: Yes), the arithmetic decoding unit 807 finishes decoding processing on the slice_data (S907).

In the macroblock, a coded parameter and compressed data (residual) are encoded according to syntax. In decoding processing, as well, the arithmetic decoding unit 807 executes analysis according to the syntax.

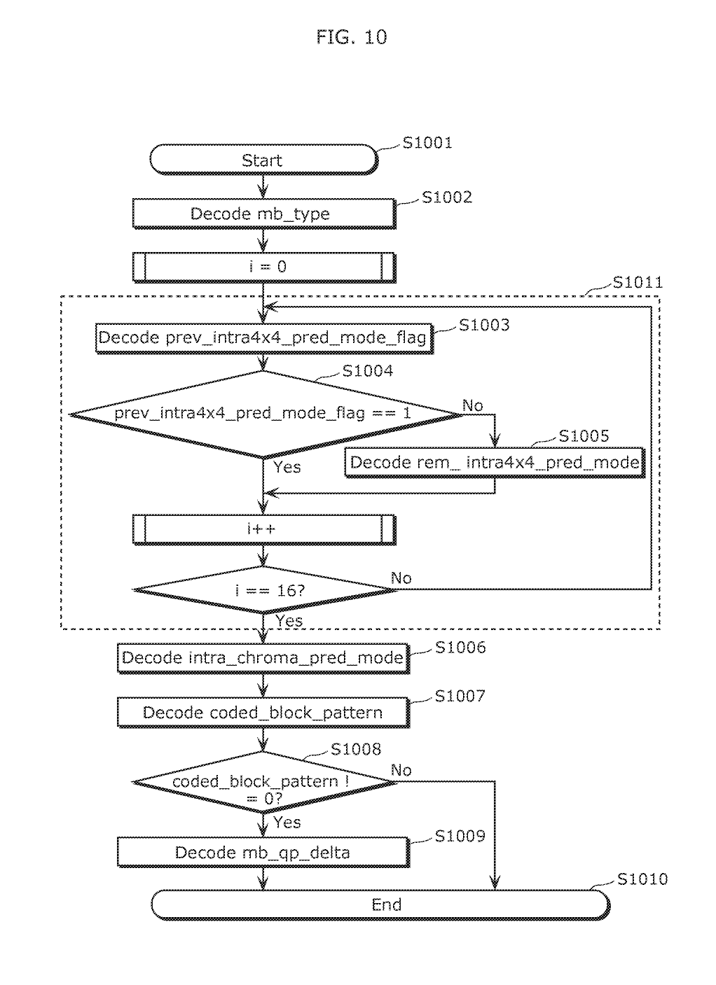

Described hereinafter is a specific syntax analysis operation, representing as an example decoding processing of a macroblock header in the case where the macroblock has an encoding type of I_N×N (for example, Intra_{—}4×4). FIG. 10 represents a syntax analysis operation to determine subsequent processing each time a parameter (multi-valued symbol) is obtained in decoding processing on a macroblock header having an encoding type of (for example, Intra_{—}4×4). In Example 1, the details of I_PCM, Intra_{—}8×8, and Inter are omitted for simplicity in the description of the syntax analysis operation.

First, a binary symbol having an mb_type is decoded (S1002). When a multi-valued symbol (mb_type) is obtained, a counter i is reset (i=0) and the operation proceeds to the next state. If I_N×N (Intra_{—}4×4) holds, the operation proceeds to analyzing syntax regarding a prediction direction in intra prediction.

In the processing loop in Step S1011, executed first is decoding of a binary symbol having a prev_intra4×4_pred_mode_flag. Then, the value of the prev_intra4×4_pred_mode_flag is determined (S1004).

If the value of the prev_intra4×4_pred_mode_flag is 0 (S1004: No), the operation proceeds to decoding processing of a rem_intra4×4_pred_mode (S1005). In contrast, if the value of the prev_intra4×4_pred_mode_flag is 1 (S1004: Yes), the counter i is incremented by 1 (i=i+1) and the operation proceeds to the decoding processing of the next prev_intra4×4_pred_mode_flag (S1003). The operation proceeds in a similar manner after the processing in Step S1005 ends.

If I_N×N (Intra_{—}4×4) holds, the loop in Step S1011 repeats 16 times (i becomes 16) and the operation proceeds to decoding processing of an intra_chroma_pred_mode (S1006). Then, after Step S1006 ends, the operation proceeds to decoding processing of a coded_block_pattern (S1007).

Next, a binary symbol having the coded_block_pattern is decoded (S1007). When a multi-valued symbol (coded_block_pattern) is obtained, the operation proceeds to the next state. Then a conditional judgment is executed with the value of the coded_block_pattern (S1008).

If coded_block_pattern!=0 holds, (S1008: Yes), the operation proceeds to decoding processing of an mb_qp_delta (S1009). if coded_block_pattern!=0 does not hold (S1008: No), the processing of the macroblock header ends (S1010). When the operation proceeds to the decoding processing of the mb_qp_delta (S1009), the binary symbol is decoded. When a multi-valued symbol (mb_qp_delta) is obtained, the processing of the macroblock header ends (S1010), Hence subsequent processing is determined according to the value of an obtained multi-valued symbol.

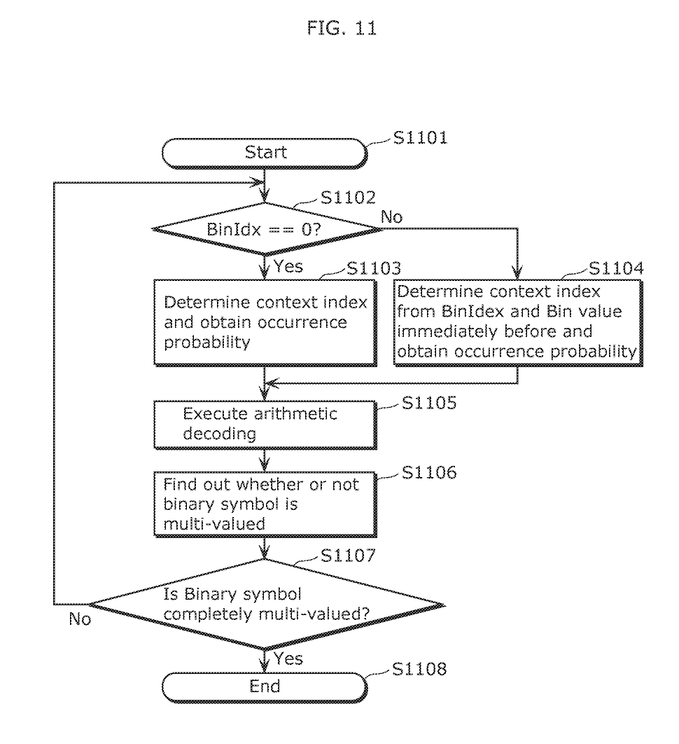

Next, FIG. 11 represents an arithmetic decoding processing operation using the mb_type as an example.

First, if BinIdx==0 (S1101: Yes), a context index is determined based on neighboring information and an occurrence probability is obtained (S1103). In contrast, if BinIdx!=0 (S1102: No), the context index is determined from the BinIdx and the Bin value immediately before and the occurrence probability is obtained (S1104). Next, based on the obtained occurrence probability, arithmetic decoding is executed (S1105), and a binary symbol is obtained, Then a determination is made to find out whether or not the binary symbol is multi-valued (S1106). Until the binary symbol is completely multi-valued (51107: Yes), the processing in FIG. 11 is repeated.

Described next is a specific operation with reference to the block diagram in FIG. 8. The arithmetic decoding unit 807, the context calculating unit 801, and the multi-value generating unit 802 synchronously operate one another according to an instruction from the control unit 803.

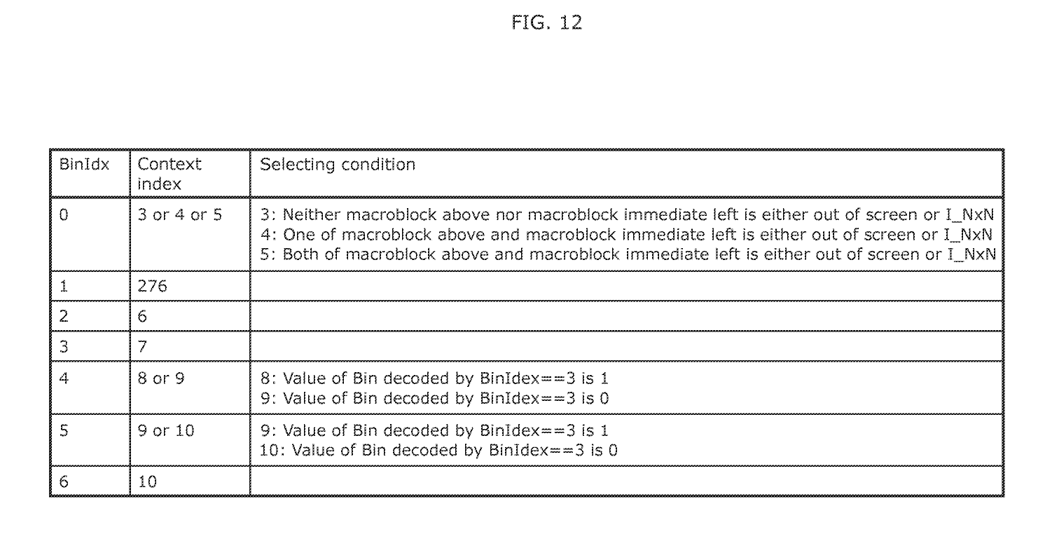

The control unit 803 notifies the context calculating unit 801 of the BinIdx of a binary symbol to be decoded next and the type of a parameter of syntax. In the case of an mb_type, the context calculating unit 801 determines a context index under the condition in FIG. 12. In contrast, in the case of BinIdx==0, the context calculating unit 801 reads a multi-valued symbol stored as a context based on the type of a parameter of syntax, and determines the context index according to the value of the multi-valued symbol.

In contrast, in the case of BinIdx!=0, the context calculating unit 801 determines a context index according to the type of a parameter of syntax, the value of the BinIdx, and the value of the binary symbol that is decoded immediately before. Then the context calculating unit 801 determines an occurrence probability according to the determined context index using a context index table, and notifies the arithmetic decoding unit 807 of the occurrence probability.

The arithmetic decoding unit 807 performs arithmetic decoding processing based on the occurrence probability to be inputted, and outputs the binary symbol. The multi-value table for an mb_type is represented in FIG. 7. For each decoding of binary symbol, the multi-value generating unit 802 holds each decoded binary symbol, and determines whether or not the binary symbol has the same bit pattern as any one of a binary symbol sequence in the multi-value table. Then, as soon as the same bit pattern is obtained, the multi-value generating unit 802 notifies the control unit 803 of the completion of the arithmetic decoding.

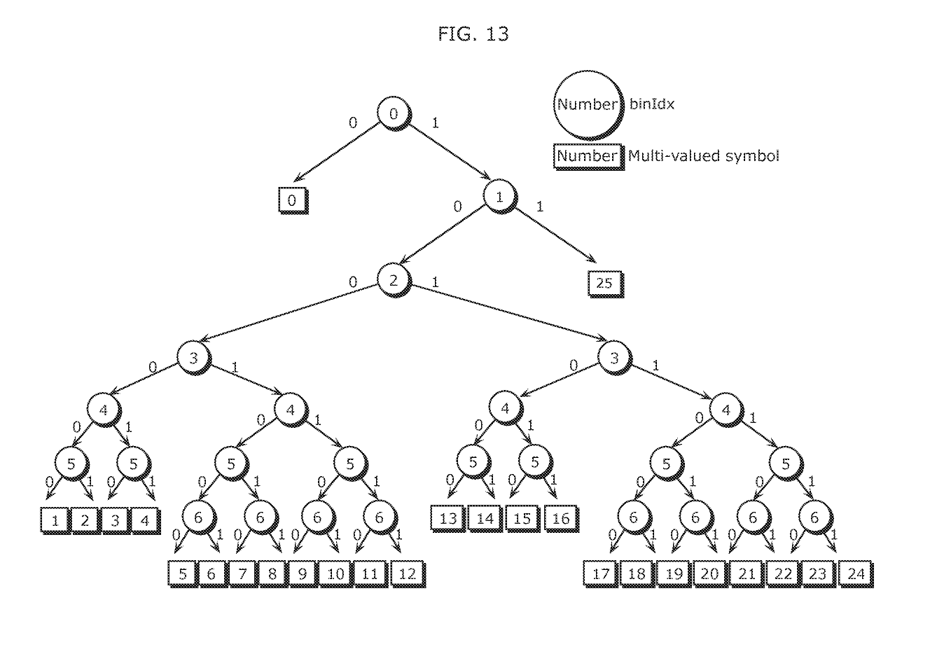

Here, the mufti-value generating unit 802 may organize multi-valued symbols in a tree structure as represented in FIG. 13. In the case of an Intra_{—}4×4, for example, the value of 0 for the first binary symbol makes it possible to visit a leaf. Hence it is determined that the decoding processing on the mb_type is complete. Furthermore, if I_{—}16×16_{—}0_{—}0_{—}0, the value of a binary symbol visits a leaf as soon as the value is outputted as 1, 0, 0, 0, 0, and 0. Hence it is determined that the decoding processing on the mb_type is complete.

The multi-value generating unit 802 outputs the obtained multi-valued symbol to the context calculating unit 801. Every time a binary symbol is decoded by the arithmetic decoding unit 807, the context calculating unit 801 updates the context index table. Every time a binary symbol is decoded by the arithmetic decoding unit 807, the control unit 803 updates the BinIdx. By obtaining a multi-valued symbol by the multi-value generating unit 802, the control unit 803 determines a parameter to be decoded next according syntax upon receiving a notification that the decoding is complete.

When performing decoding processing on multiple bitstreams, the bitstream decoding control unit 808 selects one of a bitstream A804 and a bitstream B805 and supplies the selected bitstream to the arithmetic decoding unit 807, and sends the control unit 803 a request to start decoding. Hence decoding processing on the slice_data starts. Here, suspension and resume of the decoding processing is described. Exemplified here is a case where two bitstreams A and B are decoded; however, an embodiment of the present invention shall not be limited to this. An embodiment of the present invention is applicable to decoding three or more bitstreams.

The bitstream decoding control unit 808 supplies the bitstream A804 to the arithmetic decoding unit 807, and sends the control unit 803 a request to start decoding the bitstream A804. Hence decoding processing on the slice_data in the bitstream A804 starts. When suspending the decoding processing on the bitstream A804, the bitstream decoding control unit 808 sends the control unit 803 a request to suspend decoding the bitstream A804. Hence, the decoding processing on the bitstream A804 is suspended.

The control unit 803, the arithmetic decoding unit 807, the context calculating unit 801, and the multi-value generating unit 802 hold the arithmetic decoding information at the moment of the suspension. Then, when obtaining a request to suspend decoding from the bitstream decoding control unit 808, the control unit 803 sends the arithmetic decoding information saving and returning unit 806 a request to save the arithmetic decoding information regarding the bitstream A804. Thus the arithmetic decoding information saving and returning unit 806 reads necessary information from the control unit 803, the arithmetic decoding unit 807, the context calculating unit 801, and the multi-value generating unit 802, and stores the information in the arithmetic decoding information storage memory 809.

The control unit 803 has to save at least information regarding the current position of the slice_data syntax, information regarding the current position of the macroblock syntax, and the BinIdx. Furthermore, the arithmetic decoding unit 807 has to save at least the Cod'Range and the CodIOffset. Moreover, the context calculating unit 801 has to save at least a context (multi-valued symbol), and the context index table. In addition, the multi-value generating unit 802 has to save at least one of a binary symbol of a parameter to be currently multi-valued and a transition state of a tree. Hereinafter, information which has to be saved is collectively referred to as arithmetic decoding information.

Here each of the save areas in the arithmetic decoding information storage memory 809 is logically mapped with the arithmetic decoding information regarding each of the bitstreams.

Then, when the decoding processing on the bitstream A804 is suspended, the arithmetic decoding information regarding the bitstream A804 is stored in a save area A1401 in the arithmetic decoding information storage memory 809.

Next, the bitstream decoding control unit 808 supplies the bitstream B805 to the arithmetic decoding unit 807, and sends the control unit 803 a request to start decoding processing on the bitstream B805. Hence decoding processing on the slice_data in the bitstream B805 starts. When suspending the decoding processing on the bitstream B805, the bitstream decoding control unit 808 similarly sends the control unit 803 a request to suspend decoding the bitstream B805. Hence, the decoding processing on the bitstream B805 is suspended. The control unit 803 sends the arithmetic decoding information saving and returning unit 806 a request to save the arithmetic decoding information regarding the bitstream B805, so that the arithmetic decoding information regarding the bitstream B805 is saved on a save area B1402.

When resuming the decoding processing on the bitstream A804, the bitstream decoding control unit 808 sends the control unit 803 a request to resume the decoding of the bitstream A804. The control unit 803 sends the arithmetic decoding information saving and returning unit 806 a request to return the arithmetic decoding information regarding the bitstream A804. The arithmetic decoding information saving and returning unit 806 reads necessary information from the arithmetic decoding information storage memory 809, and sets the necessary information for the control unit 803, the arithmetic decoding unit 807, the context calculating unit 801, and the multi-value generating unit 802 (in other words, the arithmetic decoding information saving and returning unit 806 returns the arithmetic decoding information).

Specifically, when resuming the decoding processing on the bitstream A804, the arithmetic decoding information saving and returning unit 806 returns, to each of the functional blocks, the arithmetic decoding information regarding the bitstream A804 stored in the save area A1401. Then, with the arithmetic decoding information returned, the control unit 803 resumes the decoding processing on the bitstream A804, Hence, the suspended decoding processing on the slice_data in the bitstream A804 is resumed.

Here the control unit 803 includes a request resister. The request resister distinguishes various types of request. For example, 0 is a request to start decoding, 1 is a request to resume decoding, 2 is a request to stop decoding, and 3 is a request to suspend decoding. It is noted that the above feature is an example, and shall not be limited to this. For example, various types of requests are written into a memory, and the types of the request made to a start-up instruction and written in the memory may be determined. Furthermore, various techniques may be used to implement the request register. Moreover, as described above, these operations may be executed by software.

In the above-described decoding device according to Example 1, the arithmetic decoder includes a context saving and returning unit which can save and return a context. Hence the context saving and returning unit allows the arithmetic decoder to suspend and resume processing with any given timing. Such a feature allows a single decoding device to stably switch, in time division, among arithmetically coded multiple bitstreams for use. As a result, the feature makes it possible to implement decoding processing on multiple bitstreams at a low cost.

It is noted that the arithmetic decoding information indicates the saving of the current position information regarding macroblock syntax, the BinIdx, the binary symbol of a parameter which is to be currently multi-valued, the CodIRange, the CodIOffset, a context (multi-valued symbol), and the context index table. This exemplifies a case of saving information required at least for decoding processing on a bitstream. A specific example of arithmetic decoding information shall not be limited to such kinds of information.

### Example 2

Described next is Example 2 which is one of the examples in the embodiment.

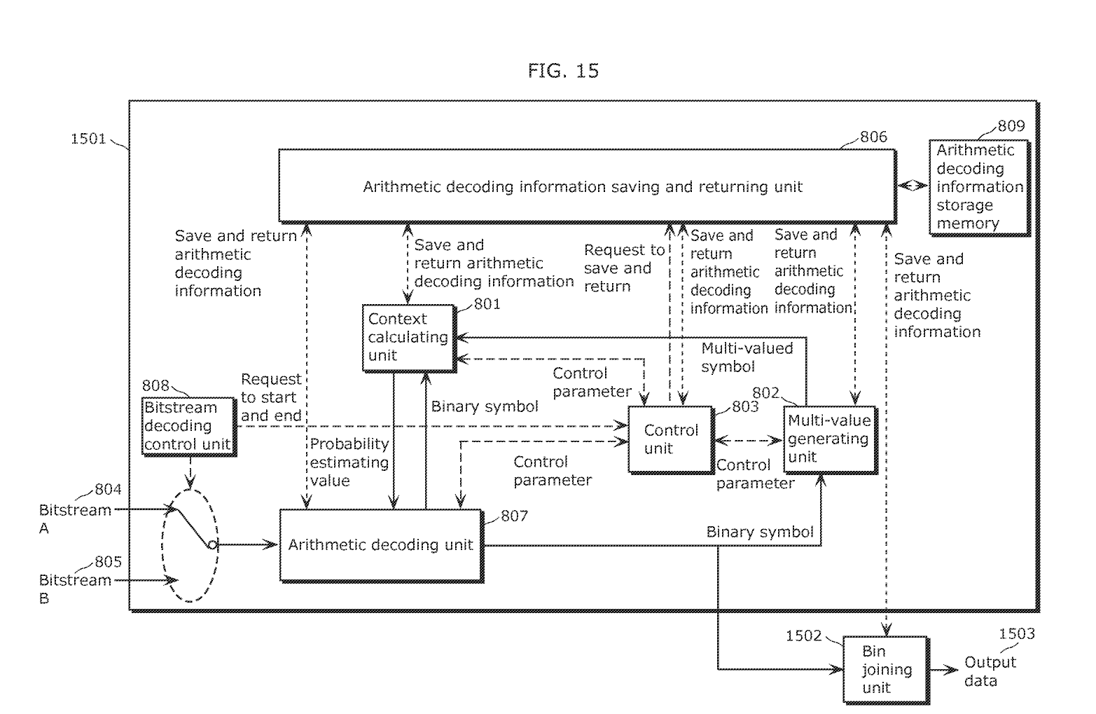

In outputting a decoding result, both a binary symbol and a multi-valued symbol may be outputted. Example 2 describes a case of outputting a binary symbol sequence, with reference to FIG. 15. FIG. 15 represents a block diagram illustrating a structure of an arithmetic decoder 1501 according to Example 2. The structures and operations shared with those described in Example 1 have the same numerical references, and the details thereof shall be omitted.

In general, data is stored in a memory such as an SRAM and a DRAM. Hence it is beneficial to have the data byte-accessed. Hence, in the case where a binary symbol is outputted, it is beneficial to have binary symbols joined together at least for one byte each (eight binary symbols) and outputted, Thus a Bin joining unit 1502 holds binary symbols outputted from the arithmetic decoding unit 807, joins the binary symbols into one-byte data, and outputs the data that joined into as output data 1503.

Here a binary symbol sequence smaller than one byte cannot be outputted, and, when the decoding processing is suspended, the arithmetic decoding information saving and returning unit 806 saves, as well as arithmetic decoding information, the symbol sequence smaller than one byte in the arithmetic decoding information storage memory 809. Then, when the decoding processing is resumed, the arithmetic decoding information saving and returning unit 806 returns the symbol sequence stored in the arithmetic decoding information storage memory 809. Such features make it possible to resume the decoding processing from the state of suspension, which allows consecutive binary symbol sequences (for each byte) to be outputted as the output data 1503.

### Example 3

Described next is Example 3 which is one of the examples in the embodiment.

In suspending and resuming decoding processing while macroblock is being processed, much information is saved and returned and the processing is complex. Hence, when the decoding processing is suspended while the macroblock is being processed, the decoding processing may return to the head of the macroblock processing, the head of a residual, or the head of a residual_block and resume. When the decoding processing on the macroblock, the residual, or the residual_block is started, it is not necessary to save information such as information regarding the current position of syntax, the BinIdx, and a binary symbol of a parameter to be currently multi-valued or transition state of a tree. Moreover, the decoding processing at the head has an advantage of alleviating complexity in suspending and resuming the decoding processing.

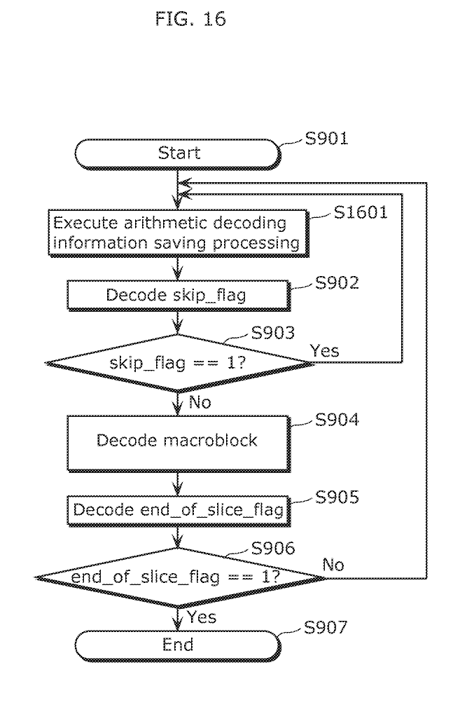

Exemplified here is a case where the decoding processing is resumed at the head of the macroblock. In switching between bitstreams to be decoded for a predetermined time period, the switching inevitably occurs while the macroblock is being processed, FIG. 16 describes a technique to save and resume information in such a case.

FIG. 16 is the processing flow of the slice_data illustrated in FIG. 9 with new processing added. The same processing between FIGS. 16 and 9 has the same numerical reference. Specifically, arithmetic decoding information saving processing (S1601) is added before the decoding of the skip_flag (S902). Here, in the arithmetic decoding information saving processing (S1601) saves, in the arithmetic decoding information storage memory 809, at least one of the CodIRange, the CodIOffset, a context (multi-valued symbol), and the context index table is saved.

Then if one of (i) skip_flag==1 (S903: Yes), in other words, a skippedmacroblock, and (ii) the decoding processing on syntax of the macroblock and the decoding processing on the end_of_slice_flag are complete (S906: No), the flow returns to the arithmetic decoding information saving processing (S1601). This is at the end of decoding of syntax indicating information regarding encoding at least one macroblock.

When suspending the decoding processing, the bitstream decoding control unit 808 sends the control unit 803 a request to suspend the decoding. Hence the decoding processing ends. Here there is no new arithmetic decoding information to be saved, and the processing ends. In contrast, when resuming the decoding processing, the bitstream decoding control unit 808 sends the control unit 803 a request to resume the decoding, as does so in Example 1. The control unit 803 sends the arithmetic decoding information saving and resuming unit 806 a request to return arithmetic decoding information. The arithmetic decoding information saving and returning unit 806 reads necessary information from the arithmetic decoding information storage memory 809, and sets the necessary information for the control unit 803, the arithmetic decoding unit 807, the context calculating unit 801, and the multi-value generating unit 802. Hence the arithmetic decoding unit 807 resumes the decoding processing as soon as the arithmetic decoding information is saved.

As described above, the image decoding device in Example 3 can minimize unnecessarily high capabilities even though going back a bitstream, and eliminate complex suspending processing while a macroblock is being processed.

It is noted that the above example represents the case of saving the arithmetic decoding information at the moment of the completion of the decoding of syntax indicating information regarding the encoding of at least one macroblock. In a case of decoding processing on consecutive macroblocks, this is when decoding processing on a subsequent macroblock starts. In addition, the arithmetic decoding information saving processing (S1601) may be executed before or after the decoding processing on a macroblock (S904). A similar effect may be achieved when the arithmetic decoding information saving processing is executed before or after the decoding processing on the residual or the residual_block.

In the above example, the arithmetic decoding information never fails to be saved for each macroblock; however, the arithmetic decoding information may be saved for any given predetermined number of macroblocks, such as once for two macroblocks.

In general, a bit stream is stored in an external memory. In supplying a bitstream at the moment of resuming, the current position (pointer) of the bitstream on the external memory may be saved when the arithmetic decoding information is saved, and at the moment of the resuming, the bitstream may be supplied at the position where saved pointer indicates. In addition, it is beneficial to leave, on the external memory, a bitstream which is consumed between at least the saving and the suspending of the arithmetic decoding information, so that the left bitstream can be supplied again at the moment of resuming.

### Example 4

Described next is Example 4 which is one of the examples in the embodiment.

Example 3 describes how to resume decoding processing at the head of a macroblock. In Example 4, instead, the decoding processing may be resumed at the head of a macroblock line. Saving arithmetic decoding information for each decoding processing unit on one macroblock increases an amount of data to be transferred to the arithmetic decoding information storage memory 809. Hence when an external memory, such as a DRAM, is used, the bandwidth is to be increased. Thus when the arithmetic decoding information is transferred at the start of decoding processing on the macroblock line, the amount of data to be transferred is beneficially reduced to 1/68 in the case of, for example, a high-definition image.

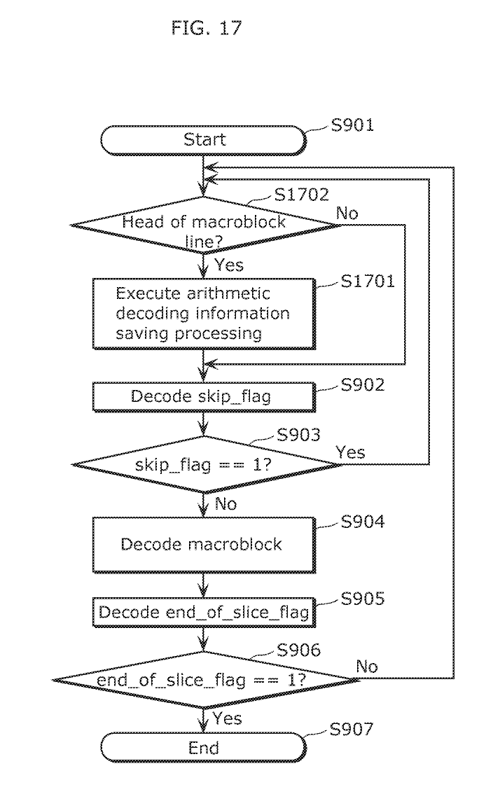

FIG. 17 is the processing flow of the slice_data illustrated in FIG. 9 with new processing added. The same processing between FIGS. 17 and 9 has the same numerical reference. Specifically, if at the head of the macroblock line (S1702: Yes), the arithmetic decoding information saving and returning unit 806 saves, in the arithmetic decoding information saving processing (S1701), at least one of the CodIRange, the CodIOffset, a context (multi-valued symbol), and the context index table in the arithmetic decoding information storage memory 809.

When suspending the decoding processing, the bitstream decoding control unit 808 sends the control unit 803 a request to suspend the decoding. Hence the decoding processing ends. Here there is no new arithmetic decoding information to be saved, and the processing ends. In contrast, when resuming the decoding processing, the bitstream decoding control unit 808 sends the control unit 803 a request to resume the decoding, as does so in Example 1. The control unit 803 sends the arithmetic decoding information saving and resuming unit 806 a request to return arithmetic decoding information. The arithmetic decoding information saving and returning unit 806 reads necessary information from the arithmetic decoding information storage memory 809, and sets the necessary information for the control unit 803, the arithmetic decoding unit 807, the context calculating unit 801, and the multi-value generating unit 802. Then the arithmetic decoding information saving and returning unit 806 resumes the decoding processing at the head of the macroblock line.

As described above, the image decoding device in Example 4 can minimize unnecessarily high capabilities even though going back a bitstream, eliminate complex suspending processing while a macroblock is being processed, and reduce the amount of data to be transferred to the arithmetic decoding information storage memory 809.

In the above example, the decoding processing is resumed at the head of the macroblock line; however, resuming the decoding processing shall not be limited to this. The decoding may be resumed at any given macroblock. Here, as a matter of course, the position of a macroblock may be used for judging a condition in Step S1702, instead of the head of a macroblock line.

### Example 5

Described next is Example 5 which is one of the examples in the embodiment.

In the embodiment, the bitstream decoding control unit 808 controls suspension and resume of decoding processing. Regarding the time when the bitstream decoding control unit 808 switches bitstreams, if there are two bitstreams which require the same bitrate as described before, it is beneficial to assign the same time for the processing time of both the bitstreams. In the case where two bitstreams—one having the bitrate of 40 Mbps and the other having the bitrate of 20 Mbps—are decoded, the bitstreams may be switched so that the time is assigned at the ratio of 4 to 2. Hence, in the case where twice as great a capability as the maximum bitrate of 40 Mbps is required when the same time is assigned, the decoding capability may be the bitrate of at least 60 Mbps. Consequently, the capability of the decoding device can be efficiently used.

It is noted that how to assign a time shall not be limited to this. Even in the case where the two bitstreams—one having the bitrate of 40 Mbps and the other having the bitrate of 20 Mbps—are decoded, the equal time may be assigned as far as the decoding capability is the bitrate of greater than or equal to 80 Mbps. A different time may be assigned according to a different element such as frame rate and image size. For example, if one of the two bitstreams has the frame rate of 30 fps and the other has the frame rate of 15 fps, the time may be assigned at the ratio of 2 to 1. Furthermore, for example, if one of the two bitstreams is for the image size of high definition (HD) and the other for the image size of standard definition (SD), the time may be assigned at the ratio of 6 to 1 that represents an approximate size ratio between the two image sizes.

### Example 6

Described next is Example 6 which is one of the examples in the embodiment.

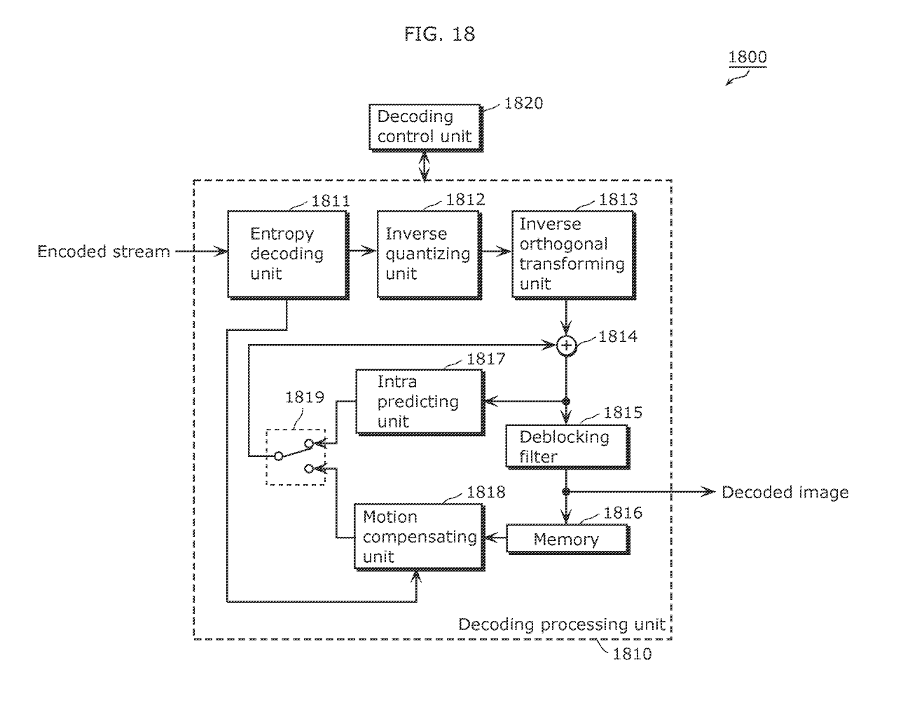

FIG. 18 represents a block diagram illustrating a structure of an image decoding device according to the embodiment. An image decoding device 1800 represented in FIG. 18 includes a decoding processing unit 1810 and a decoding control unit 1820. The decoding processing unit 1810 sequentially decodes encoded data blocks included in an encoded stream, and generates a decoded image including multiple decoded blocks.

As represented in FIG. 18, the decoding processing unit 1810 includes an entropy decoding unit 1811, an inverse quantizing unit 1812, an inverse orthogonal transforming unit 1813, an adder 1814, a deblocking filter 1815, a memory 1816, an intra predicting unit 1817, a motion compensating unit 1818, and a switch 1819.

The entropy decoding unit 1811 obtains an encoded stream, and performs entropy decoding (variable length decoding) on the encoded stream. The arithmetic decoders 800 and 1501 represented in FIGS. 8 and 15 correspond to the entropy decoding unit 1811, for example.

The inverse quantizing unit 1812 performs inverse quantization on a quantized coefficient block which is generated by the entropy decoding unit 1811 performing the entropy decoding. The inverse orthogonal transforming unit 1813 performs inverse orthogonal transformation, such as inverse discrete cosine transformation, on each of frequency coefficients included in the inverse-quantized coefficient block, and generates a decoded residual image.

The adder 1814 obtains a prediction image from the switch 1819, and adds the prediction image to the decoded residual image generated by the inverse orthogonal transforming unit 1813 to generate a decoded image (decoded block).

The deblocking filter 1815 removes an artifact of the decoded image generated by the adder 1814, stores the decoded image in the memory 1816, and outputs the decoded image.

The intra predicting unit 1817 performs intra prediction on a block to be decoded, using the decoded image generated by the adder 1814, to generate a prediction image.

The motion compensating unit 1818 performs motion compensation on the block to be decoded in an image stored in the memory 1816, using a reference image and a motion vector. Performing the motion compensation, the motion compensating unit 1818 generates a prediction image with respect to the block to be decoded. A technique to obtain the motion vector shall be described later.

The switch 1819 provides the adder 1814 with a prediction image generated by the intra predicting unit 1817 if the block to be decoded is encoded by intra prediction. In contrast, the switch 1819 provides the adder 1814 with a prediction image generated by the motion compensating unit 1818 if the block to be decoded is encoded by inter prediction.

The decoding control unit 1820 controls the decoding processing unit 1810. For example, the decoding control unit 1820 determines the structure of an encoded data block, and obtains a motion vector using a technique depending on the determined data.

### Other Embodiments

It is noted that the present invention has been described according to the above embodiment. As a matter of course, however, the present invention shall not be limited to the above embodiment. The modifications of the embodiment below are included in the present invention.

For example, each of the aforementioned devices is, specifically, a computer system including a microprocessor, a ROM, a RAM, a hard disk unit, a display unit, a keyboard, a mouse, and so on. The RAM or hard disk unit stores a computer program. The devices achieve their functions through the microprocessor's operation according to the computer program. Here, in order to achieve the predetermined functions, the computer program is configured by combining instruction codes indicating instructions to the computer.

A part or all of the constituent elements constituting the respective devices may be configured from a single System-LSI (Large-Scale Integration). The System-LSI is a super-multi-function LSI manufactured by integrating constituent units on one chip. Specifically, the System-LSI is a computer system including a microprocessor, a ROM, a RAM, or by means of a similar device, The RAM stores a computer program. The System-LSI performs its functions through the microprocessor's operation according to the computer program.

A part or all of the constituent elements constituting the each of the devices may be configured as an IC card which can be attached to and detached from each device or as a stand-alone module. The

IC card or the module is a computer system configured from a microprocessor, a ROM, and a RAM. The IC card or the module may also be included in the aforementioned super-multi-function LSI. The IC card or the module achieves its functions through the microprocessor's operation according to the computer program. The IC card or the module may also be implemented to be tamper-resistant.

The aforementioned method may be a computer program for implementing the above method on a computer, and may also be a digital signal including the computer program.

Furthermore, the computer program or the digital signal may be stored in a computer-readable recording medium such as a flexible disk, a hard disk a CD-ROM, an MO, a DVD, a DVD-ROM, a DVD-RAM, a BD (Blu-ray Disc), and semiconductor memory. Furthermore, the computer program or the digital signal may also be the digital signal recorded in these recording media.

Furthermore, each of the devices and the method may transmit the aforementioned computer program or digital signal via a telecommunication line, a wireless or wired communication line, a network represented by the Internet, and data broadcast.

Furthermore, each of the aforementioned devices may also be a computer system including a microprocessor and a memory, in which the memory stores the aforementioned computer program and the microprocessor operates according to the computer program.

Furthermore, the above program or the above digital signal may be recorded on the above non-transitory computer-readable recording media for their transportation or transmitted via the above network in order to be executed on another independent computer system.

In addition, the above embodiment and modifications may be combined with one another.

The embodiment according to the present invention has been described above with reference to the drawings; however, the present invention shall not be limited to the embodiment. The embodiment may receive various adjustments and modifications which are equivalent to and within the scope of the present invention.

### INDUSTRIAL APPLICABILITY

As described above, the embodiment allows a single decoding device to stably switch, in time division, among arithmetically coded multiple bitstreams for use. Hence, an embodiment of the present invention is useful for devices such as image decoding devices. An embodiment of the present invention is further useful for devices, such as optical-disc reproducing devices and recording devices, digital TV receiving devices, movie devices, cellular phones, and tablet terminals.

1. An image decoding device which decodes bitstreams, the image decoding device comprising:
an arithmetic decoding unit configured to perform arithmetic decoding of a bitstream to be inputted to obtain a binary symbol; and
a control unit configured to select a bitstream on which the arithmetic decoding is performed by the arithmetic decoding unit,
wherein the control unit is configured to cause the arithmetic decoding unit to:
suspend the arithmetic decoding of one of the bitstreams and start the arithmetic decoding of an other one of the bitstreams, at a time point when a predetermined time period elapses; and
suspend the arithmetic decoding of the other one bitstream and resume the arithmetic decoding of the one bitstream at a time point when another predetermined time period elapses.

2. The image decoding device according to claim 1, further comprising
an arithmetic decoding information saving and returning unit configured to:
save, as saved data, arithmetic decoding information regarding the one bitstream held in the arithmetic decoding unit, when the arithmetic decoding unit suspends the arithmetic decoding of the one bitstream; and
return the saved data to the arithmetic decoding unit when the arithmetic decoding unit resumes the arithmetic decoding of the one bitstream.

3. The image decoding device according to claim 1, further comprising
an arithmetic decoding information saving and returning unit configured to:
for each of units of decoding processing in any given number including at least one, save, as saved data, arithmetic decoding information regarding the one bitstream on which the arithmetic decoding is performed by the arithmetic decoding unit; and
return the saved data to the arithmetic decoding unit when the arithmetic decoding unit resumes the arithmetic decoding of the one bitstream.

4. The image decoding device according to claim 3,
wherein each of the units of the decoding processing is a macroblock line.

5. The image decoding device according to claim 3,
wherein each of the units of the decoding processing is a macroblock.

6. The image decoding device according to claim 3,
wherein each of the units of the decoding processing is a residual.

7. The image decoding device according to claim 3,
wherein each of the units of the decoding processing is a residual_block.

8. The image decoding device according to claim 1,
wherein the predetermined time period is determined by a bitrate of a bitstream.

9. The image decoding device according to claim 1,
wherein the predetermined time period is determined according to a display rate time of a decoded image.

10. The image decoding device according to claim 1,
wherein the predetermined time period is deter mined according to an image size of a decoded image.

11. The image decoding device according to claim 2,
wherein the arithmetic decoding information includes at least current position information regarding syntax.

12. The image decoding device according to claim 2,
wherein the arithmetic decoding information includes at least a BinIdx.

13. The image decoding device according to claim 2,
wherein the arithmetic decoding information includes at least a CodIRange and a CodIOffset.

14. The image decoding device according to claim 2,
wherein the arithmetic decoding information includes at least a context.

15. The image decoding device according to claim 2,
wherein the arithmetic decoding information includes at least a context index table.

16. The image decoding device according to claim 2,
wherein the arithmetic decoding information includes at least a decoded binary symbol.

17. The image decoding device according to claim 1, further comprising
an arithmetic decoding information saving and returning unit configured to save, as saved data at a predetermined time point, arithmetic decoding information being processed by the arithmetic decoding unit.

18. The image decoding device according to claim 17,
wherein the predetermined time point is when decoding is suspended.

19. The image decoding device according to claim 17,
wherein the predetermined time point is when decoding of a macroblock starts.

20. The image decoding device according to claim 17,
wherein the predetermined time point is when decoding of a residual starts.

21. The image decoding device according to claim 17,
wherein the predetermined time point is when decoding of a residual_block starts.
